(19) United States
(12) Patent Application Publication
(10) Pub. No.: US 2010/0155565 A1
(43) Pub. Date: Jun. 24, 2010

(54) METHOD AND APPARATUS FOR AFFIXING OBJECTS TO A WALL

(76) Inventor: Jay Alan Bernstein, Boca Raton, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 2022, BOCA RATON, FL, 33487, US

(21) Appl. No.: 12/337,883

(22) Filed: Dec. 18, 2008

(51) Int. Cl. A47G 1/17; G01C 9/00; A47F 5/08

(52) U.S. Cl. 248/467; 33/451; 211/90.01

(57) ABSTRACT

An apparatus for facilitating the affixing of an object to a wall is disclosed. The apparatus includes a vertical first planar element and having front and back sides. The apparatus further includes a horizontal level for horizontally leveling the apparatus and adhesive disposed on the back side of the first planar element for removably affixing the apparatus to the wall horizontally level. The apparatus further includes a second planar element coupled perpendicularly with the first planar element for supporting the object when placed on top of the apparatus and a horizontal lip on an edge of the second planar element, the lip for arresting movement of the object when resting on top of the apparatus. The apparatus further includes a ruler horizontally embedded in the apparatus, the ruler for measuring placement of the object on the apparatus.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of affixing objects to a wall. More specifically, the embodiments of the present invention relate to a method and apparatus for allowing a person acting alone to correctly position objects on a wall.

### BACKGROUND OF THE INVENTION

The affixing of objects to a wall, such as pictures, diplomas, frames or sconces, can be a difficult task. Typically, the process of affixing an object to a wall begins with a user placing the object upon the wall using only his hands to support the object. The user then reviews the placement of the object to determine whether it appears well-positioned. But because the user is standing close to the wall and holding up the object, the user acting alone cannot view the object against the wall from a distance. Thus, a user acting alone cannot properly determine the appropriate location of an object against a wall. Additionally, a person acting alone cannot, without great difficulty, mark the location of a nail or other fastener upon the wall while holding up the object at the same time. For this reason, two people are often needed so that one person may hold the object against the wall and the second person may review the placement of the object from a distance and mark the appropriate location of a nail upon the wall.

Another problem associated with affixing objects to a wall is determining a horizontally level position of the object against the wall. Again, a user typically places the object upon the wall with his hands to support the object and then reviews the placement of the object to determine whether it appears horizontally level. Since the user is standing close to the wall and holding up the object, the user acting alone cannot determine whether the object is horizontally level with great accuracy. For this task, a user often seeks the help of a second person so that the second person can review the horizontal placement of the object while the user holds up the object.

Because the aforementioned tasks require the use of a second person, users acting alone must make due. Often, a single user will simply guess as to the placement of nails or other fasteners upon the wall and then place the object upon the nails. Subsequently, the user backs up to view the object and determine if the object is located in the correct position and if the object is horizontally level. If the user's guess was incorrect, the user must then remove the nails, guess as to a new location for the nails and then repeat the process. This trial and error procedure can be time-consuming and tedious for the user and can further lead to damage to the wall.

Therefore, a need exists to overcome the problems with the prior art as discussed above, and particularly for a more efficient way for a single person to affix objects onto a wall while eliminating or reducing unnecessary damage to the wall.

### SUMMARY OF THE INVENTION

According to an embodiment of the present invention, an apparatus for facilitating the affixing of an object to a wall is disclosed. The apparatus includes a first planar element disposed vertically and having front and back sides. The apparatus further includes a horizontal level for measuring a horizontally level position of the apparatus and adhesive disposed on a back side of the first planar element, the adhesive for removably affixing the apparatus to the wall in the horizontally level position. The apparatus further includes a second planar element coupled perpendicularly with the front side of the first planar element so as to support the object when placed on top of the second planar element and a lip disposed horizontally along an edge of the second planar element, the lip for arresting movement of the object when resting on top of the second planar element. The apparatus further includes a ruler horizontally embedded in the apparatus, the ruler for measuring placement of the object on the apparatus.

In another embodiment of the present invention an apparatus for facilitating the affixing of an object to a wall is disclosed. The apparatus includes a first planar element disposed vertically and having front and back sides and a horizontal level for measuring a horizontally level position of the apparatus. The apparatus further includes a second planar element coupled perpendicularly with the front side of the first planar element so as to support the object when placed on top of the second planar element and adhesive tabs disposed on a back side of the first planar element, the adhesive tabs for removably affixing the apparatus to the wall in the horizontally level position. Each adhesive tab comprises a first strip having adhesive on a first side and a hook and loop element on a second side, wherein the first side of the first strip is securely affixed to the back side of the first planar element, and a second strip having removable adhesive on the first side and a hook and loop element on the second side, wherein the second side of the second strip is removably coupled with the second side of the first strip and wherein the first side of the second strip is removably coupled with the wall.

In another embodiment of the present invention, a system for facilitating the affixing of a plurality of objects to a wall is disclosed. The system includes a first apparatus comprising a first planar element disposed vertically and having front and back sides, adhesive disposed on a back side of the first planar element, the adhesive for removably affixing the first apparatus to the wall in a horizontally level position and a second planar element coupled perpendicularly with the front side of the first planar element so as to support a first object when placed on top of the second planar element. The system further includes a second apparatus comprising a third planar element disposed vertically and having front and back sides, adhesive disposed on a back side of the third planar element, the adhesive for removably affixing the third planar element to the wall in a horizontally level position, and a fourth planar element coupled perpendicularly with the front side of the third planar element so as to support a second object when placed on top of the fourth planar element. The system further includes a joint for coupling the first apparatus with the second apparatus such that the second and fourth planar elements are coplanar.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a top perspective view of a shelf-like apparatus for facilitating affixing of objects onto a wall, in accordance with the embodiments of the present invention.

FIG. 2 is a bottom perspective view of a shelf-like apparatus for facilitating affixing of objects onto a wall, in accordance with the embodiments of the present invention.

FIG. 3 is a side view of a shelf-like apparatus for facilitating affixing of objects onto a wall, in accordance with the embodiments of the present invention.

FIG. 4 is a frontal view of multiple shelf-like apparatuses for facilitating affixing multiple objects onto a wall, in accordance with the embodiments of the present invention.

### DETAILED DESCRIPTION

The present invention solves problems associated with the prior art by providing a quick and efficient way for a user acting alone to temporarily position an object, such as a picture frame or art work, on a wall and view the picture from a distance. The present invention utilizes a shelf-like apparatus that is temporarily affixed to a wall using an adhesive that can be easily removed from the wall without causing damage. Once the shelf-like apparatus is affixed to a wall, the picture can be placed on top of the apparatus so that the user may back up to view the picture from a distance. The shelf-like apparatus can be easily moved to a new location without causing damage to the wall or its surrounding areas. When the user is satisfied with the placement of the picture, the user may calculate a location on the wall for a fastener, such as an adhesive, for attaching the picture to the wall. A level and a ruler may be embedded in the shelf-like apparatus to aid the user in horizontally leveling the apparatus and measuring the placement of the picture. Also, multiple shelf-like apparatuses may be combined to provide more shelf space for supporting multiple objects.

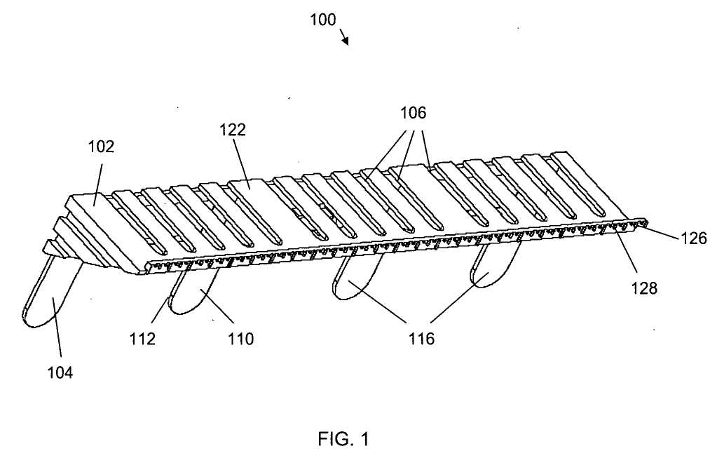

FIG. 1 is a top perspective view of the shelf-like apparatus 100, which comprises a top planar element 102 having a substantially rectangular shape and positioned parallel to the ground. Note the top planar element 102 includes multiple cutouts 106, which lightens the weight of the apparatus 100. The top planar element 102 is further perpendicularly connected to back planar element 104 having a front side 110 and a back side 112. The back planar element 104 also comprises a substantially rectangular shape but includes multiple strips 116 extending downwards from the back planar element 104 so as to provide additional vertical support.

When in use, the back side 112 is temporarily affixed to a wall using an adhesive (not shown) on the back side 112. Subsequently, the object being affixed to a wall, such as a picture frame, is placed on the top 122 of top planar element 102 such that the weight of the object rests upon the top 122 of planar element 102. A lip 126 is an elongated strip positioned along the outside edge of the top planar element 102 and provides a barrier such that the picture frame resting upon top 122 of planar element 102 cannot slide off the top planar element 102. Further, a ruler 128 comprising a plurality of tick marks can be embedded in the outside surface of lip 126 of the top planar element 102 so as to provide a method for measuring the placement of the picture frame on the apparatus 100.

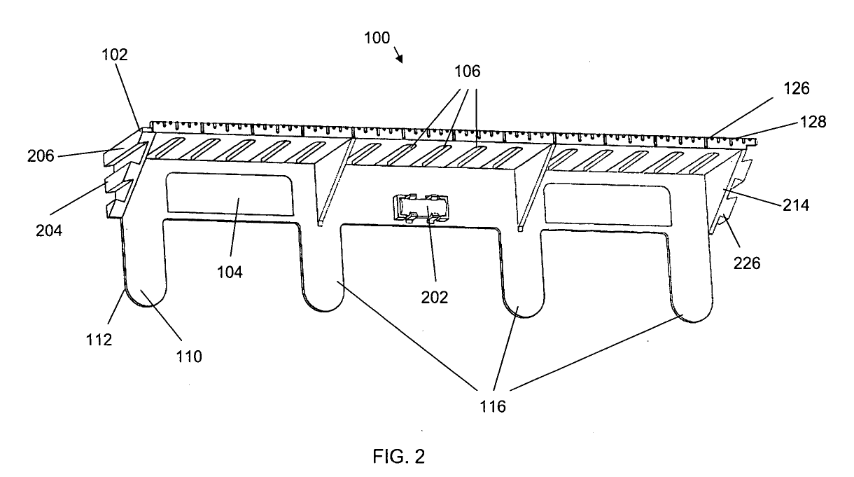

FIG. 2 is a bottom perspective view of the shelf-like apparatus 100. FIG. 2 shows a horizontally positioned level 202 coupled to a center point of the front side 110 of back planar element 104. The level 202 is used for calculating a horizontally level position of the apparatus 100 when being temporarily affixed on the wall. This, in turn, allows a picture frame to be placed in a horizontally level position when the picture frame rests on top of the apparatus 100. The level 202 may be coupled to the back planar element 104 via pressure tabs that protrude from the front side 110 of the back planar element 104. The level 202 may be a conventional level including a gas bubble suspended in a viscous fluid or may be an electronic level.

FIG. 2 also shows side supports 204 and 214, each of which comprises a substantially triangular-shaped planar element that intersects perpendicularly with both top planar element 102 and back planar element 104 so as to provide support for the joint between top planar element 102 and back planar element 104. Along the outside surface of side supports 204, 214 are corrugated surface 206, 226, respectively, used to provide a dovetail joint between two apparatuses 100. A dovetail joint includes a series of trapezoidal shapes cut into one surface so that the trapezoids may interlock with a series of complementary trapezoids cut into another surface. In this manner, apparatus 100 may be interlocked or joined with another apparatus of the same type, as described in greater detail below.

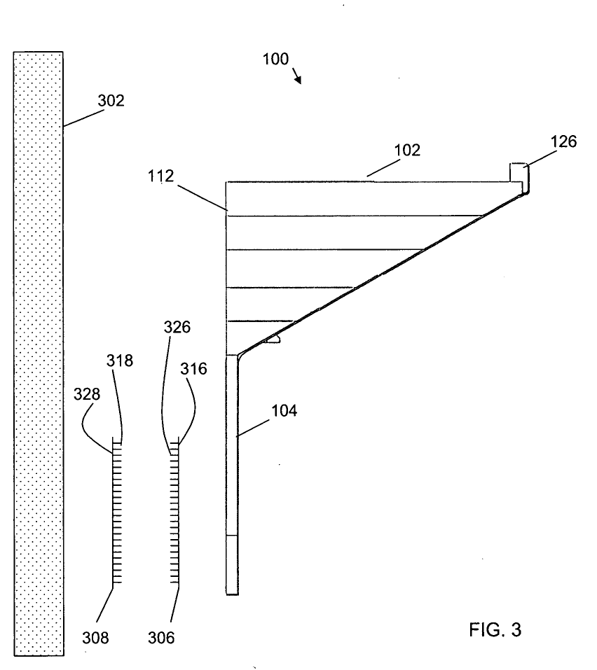

With reference to FIG. 3 below, a method for a single user to affix one or more objects to a wall while reducing or eliminating damage to the wall shall now be described. The method begins with the user reading the level 202 so as to calculate a horizontally level position for the apparatus 100 upon the wall 302. Next, the user temporarily affixes the apparatus 100 to the wall in the horizontally level position that was calculated. In one embodiment of the present invention, the apparatus 100 is temporarily affixed to the wall 302 using an adhesive disposed upon the back side 112 of the back planar element 104. The adhesive may exhibit enough strength to secure the apparatus 100 (and any object placed on top of the apparatus 100) upon the wall 302 while still allowing the apparatus 100 to be removed from the wall 302 without causing damage to the paint, drywall or any other portion of the wall 302. Using this embodiment, a user can affix the apparatus 100 to the wall 302, place an object, such as a picture frame, on top of the apparatus 100 and proceed to back up and view the apparatus 100 from a distance. If the user is not satisfied with the placement of the picture frame upon the wall 302, the user may remove the apparatus 100 from the wall 302 without causing damage to the wall and repeat the process until an appropriate location for the picture frame is found.

In another embodiment of the present invention, the apparatus 100 is temporarily affixed to the wall 302 using one or more hook and loop adhesive tabs 304 disposed upon the back side 112 of the back planar element 104. A hook and loop adhesive tab 304 includes a first strip 306 having adhesive 316 on one side and a hook and loop element 326 on another side, wherein the adhesive 316 of the first strip 306 is securely affixed to the back side 112 of the back planar element 104. The hook and loop adhesive tab 304 further includes a second strip 308 having removable adhesive 328 on one side and a hook and loop element 318 on the other side, wherein the hook and loop element 318 of the second strip 308 is removably coupled in a hook and loop juncture with the hook and loop element 326 of the first strip 306 and wherein the adhesive 328 of the second strip 308 is removably coupled with the wall 302. A protective layer may be removed from the adhesive 328 before it can be applied to the wall 302. The adhesive 328 may exhibit enough strength to secure the apparatus 100 (and any object placed on top of the apparatus 100) upon the wall 302 while still allowing the apparatus 100 to be removed from the wall 302 without causing damage to the paint, drywall or any other portion of the wall 302.

Furthermore, the embodiment above allows a user to temporarily affix the second strip 308 onto the wall 302 and subsequently to attach the first strip 306 to the second strip 308, thereby securing the apparatus 100 to the wall 302. Next, the user may remove the apparatus 100 from the wall 302 by separating the first strip 306 from the second strip 308 while allowing the second strip 308 to remain on the wall 302. Then, the user may identify a new location for the apparatus 100 upon the wall 302 and, as long as the first strip 306 and second strip 308 substantially overlap, may proceed to attach the first strip 306 to the new location on the second strip 308, thereby securing the apparatus 100 to the wall 302 in a new position. Further, additional strips may be added to the wall 302 so as to allow greater vertical and horizontal movement of the apparatus 100 to new locations on the wall 302. Using this embodiment, a user can affix the apparatus 100 to the wall 302, place a picture frame on top of the apparatus 100 and proceed to back up and view the apparatus 100 from a distance. If the user is not satisfied with the placement of the picture frame upon the wall 302, the user may remove the apparatus 100 from the wall 302 without causing damage to the wall and repeat the process until an appropriate location for the picture frame is found.

The method for a single user to affix one or more objects to a wall continues with the measurement of a location for a fastener or fasteners to be placed upon the wall. A fastener may include an adhesive or an adhesive tab as described above or any other mechanism for attaching an object to a wall without causing damage to the wall. A fastener may further include a nail, a nail and hook combination, a wall anchor, a pin, an in-wall hook or any other mechanism for attaching an object to a wall by causing damage to the wall. Once the user has found an appropriate location for the object upon the wall 302, the user 302 proceeds to affix the object to the wall 302. If adhesive or adhesive tabs are used on the back side of the object, then the user simply applies pressure to the object so as to affix the object to the wall via the adhesive or adhesive tabs. If a nail or other hardware is used to affix the object to the wall, then the user first identifies a location for the fastener upon the wall 302, places a mark upon the wall 302 at the identified location, removes the apparatus 100 and the object from the wall 302, affixes the fastener to the wall at the identified location and couples the object to the wall 302 via the fastener.

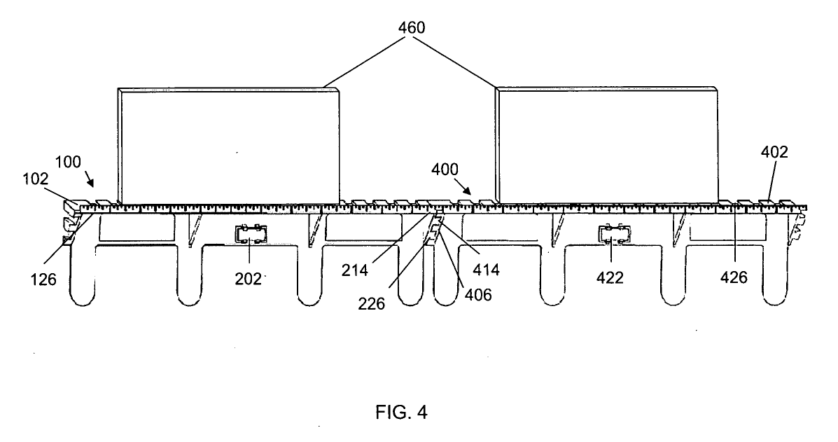

In one embodiment of the present invention, multiple apparatuses 100 may be used to facilitate a single user affixing multiple objects 460 onto the wall 302 while reducing or eliminating damage to the wall. FIG. 4 shows a first apparatus 100 coupled with a second apparatus 400 such that the top planar element 102 of the first apparatus 100 is coplanar with the top planar element 402 of the second apparatus 400. Specifically, note that the corrugated surface 226 of side support 214 of the first apparatus 100 is coupled with the corrugated surface 406 of side support 414 of the second apparatus 400 in a dovetail joint.

Similar to the use of one apparatus 100, the method of utilizing two apparatuses 100, 400 to facilitate affixing multiple objects 460 to the wall 302 begins with the user reading the levels 202, 422 so as to calculate a horizontally level position for the apparatuses 100, 400 upon the wall 302. Next, the user temporarily affixes the apparatuses 100, 400 to the wall in the horizontally level position that was calculated. Then, the user places the multiple objects 460 upon the apparatuses 100, 400, using the rulers 126, 426 to measure the appropriate distance between the two objects 460. That is, the rulers 126, 426 are used to measure uniform or pre-calculated distances between successive objects on the apparatuses 100, 400. Because the apparatuses 100, 400 are coplanar, the multiple objects 460 are on the same horizontal level.

Once the user has found an appropriate location for the objects 460 upon the wall 302, the user proceeds to affix the objects 460 to the wall 302. If adhesive or adhesive tabs are used on the back side of each object, then the user simply applies pressure to each object so as to affix the object to the wall via the adhesive or adhesive tabs. If a nail or other hardware is used to affix the objects to the wall, then the user first identifies a location for each fastener upon the wall 302, places a mark for each fastener upon the wall 302 at the identified locations, removes the apparatuses 100, 400 and the objects 460 from the wall 302, affixes the fasteners to the wall 302 at the identified locations and couples the objects 460 to the wall 302 via the fasteners.

Thus, the use of the apparatuses 100, 400 in conjunction allows a single user to affix multiple objects 460 on the wall 302 on a horizontal level with a uniform distance between the objects 460. Note that although FIG. 4 shows only two apparatuses 100, 400 conjoined for use, the present invention supports the combination of any number of such apparatuses for facilitating the affixing of multiple objects to a wall.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. An apparatus for facilitating the affixing of an object to a wall, comprising:
a first planar element disposed vertically and having a front side and a back side opposite the front side, a left side edge and a right side edge opposite the left side edge;
a horizontal level for measuring a horizontally level position of the apparatus, the horizontal level coupled to the first planar element;
adhesive disposed on a back side of the first planar element, the adhesive for removably affixing the apparatus to the wall in the horizontally level position;
a second planar element having a front side and a back side opposite the front side, a left side edge and a right side edge opposite the left side edge, the second planar element coupled perpendicularly with the front side of the first planar element so as to support the object when placed on top of the second planar element;
a lip disposed horizontally along an edge of the second planar element, the lip for arresting movement of the object when resting on top of the second planar element;
a first side support having an inside surface and an outside surface opposite the inside surface, the inside surface of the first side support coupled to the right side edge of the first planar element and the right side edge of the second planar element, wherein the outside surface of the first side support is corrugated and configured to define a first half of a joint;
a second side support having an inside surface and an outside surface opposite the inside surface, the inside surface of the second side support coupled to the left side edge of the first planar element and the second side edge of the second planar element, wherein the outside surface of the second side support is corrugated and configured to define a second half of the joint; and,
a ruler horizontally embedded in the apparatus, the ruler for measuring placement of the object on the apparatus.

2. The apparatus of claim 1, wherein the first planar element further comprises at least one strip extending downwards for providing vertical support.

3. The apparatus of claim 1, wherein the level is coupled to a center of the front side of the first planar element.

4. The apparatus of claim 1, wherein the adhesive comprises a plurality of adhesive tabs.

5. The apparatus of claim 4, wherein each adhesive tab comprises a rectangular area of the back side of the first planar element.

6. The apparatus of claim 4, wherein each adhesive tab comprises:
a first strip having adhesive on a first side and a hook and loop element on a second side, wherein the first side of the first strip is securely affixed to the back side of the first planar element;
a second strip having removable adhesive on the first side and a hook and loop element on the second side, wherein the second side of the second strip is removably coupled with the second side of the first strip and wherein the first side of the second strip is removably coupled with the wall.

7. An apparatus for facilitating the affixing of an object to a wall, comprising:
a first planar element disposed vertically and having a front side and a back side opposite the front side, a left side edge and a right side edge opposite the left side edge;
a horizontal level for measuring a horizontally level position of the apparatus, the horizontal level coupled to the first planar element;
a second planar element having a front side and a back side opposite the front side, a left side edge and a right side edge opposite the left side edge, the second planar element coupled perpendicularly with the front side of the first planar element so as to support the object when placed on top of the second planar element;
a first side support having an inside surface and an outside surface opposite the inside surface, the inside surface of the first side support coupled to the right side edge of the first planar element and the right side edge of the second planar element, wherein the outside surface of the first side support is corrugated and configured to define a first half of a joint;
a second side support having an inside surface and an outside surface opposite the inside surface, the inside surface of the second side support coupled to the left side edge of the first planar element and the second side edge of the second planar element, wherein the outside surface of the second side support is corrugated and configured to define a second half of the joint; and,
adhesive tabs disposed on a back side of the first planar element, the adhesive tabs for removably affixing the apparatus to the wall in the horizontally level position, wherein each adhesive tab comprises:
a first strip having adhesive on a first side and a hook and loop element on a second side, wherein the first side of the first strip is securely affixed to the back side of the first planar element;
a second strip having removable adhesive on the first side and a hook and loop element on the second side, wherein the second side of the second strip is removably coupled with the second side of the first strip and wherein the first side of the second strip is removably coupled with the wall.

8. The apparatus of claim 7, further comprising:
a lip disposed horizontally along an edge of the second planar element, the lip for arresting movement of the object when resting on top of the second planar element.

9. The apparatus of claim 8, further comprising:
a ruler horizontally embedded in the apparatus, the ruler for measuring placement of the object on the apparatus.

10. The apparatus of claim 9, wherein the first planar element further comprises at least one strip extending downwards for providing vertical support.

11. The apparatus of claim 10, wherein the level is coupled to a center of the front side of the first planar element.

12. A system for facilitating the affixing of a plurality of objects to a wall, comprising:
a first apparatus comprising:
a first planar element disposed vertically and having a front side and a back side opposite the front side, a left side edge and a right side edge opposite the left side edge;
adhesive disposed on a back side of the first planar element, the adhesive for removably affixing the first apparatus to the wall in a horizontally level position;
a second planar element having a front side and a back side opposite the front side, a left side edge and a right side edge opposite the left side edge, the second planar element coupled perpendicularly with the front side of the first planar element so as to support the object when placed on top of the second planar element;
a first side support having an inside surface and an outside surface opposite the inside surface, the inside surface of the first side support coupled to the right side edge of the first planar element and the right side edge of the second planar element, wherein the outside surface of the first side support is corrugated and configured to define a first half of a joint; and,
a second side support having an inside surface and an outside surface opposite the inside surface, the inside surface of the second side support coupled to the left side edge of the first planar element and the second side edge of the second planar element, wherein the outside surface of the second side support is corrugated and configured to define a second half of the joint; and,
a second apparatus comprising:
a third planar element disposed vertically and having a front side and a back side opposite the front side, a left side edge and a right side edge opposite the left side edge;
adhesive disposed on a back side of the third planar element, the adhesive for removably affixing the third planar element to the wall in a horizontally level position;
a fourth planar element having a front side and a back side opposite the front side, a left side edge and a right side edge opposite the left side edge, the fourth planar element coupled perpendicularly with the front side of the third planar element so as to support a second object when placed on top of the fourth planar element;
a third side support having an inside surface and an outside surface opposite the inside surface, the inside surface of the third side support coupled to the right side edge of the third planar element and the right side edge of the fourth planar element, wherein the outside surface of the third side support is corrugated and configured to define a first half of a joint; and,
a fourth side support having an inside surface and an outside surface opposite the inside surface, the inside surface of the fourth side support coupled to the left side edge of the third planar element and the second side edge of the fourth planar element, wherein the outside surface of the fourth side support is corrugated and configured to define a second half of the joint;
the joint formed by coupling the second side support of the first apparatus to the third side support of the second apparatus, the joint for coupling the first apparatus with the second apparatus such that the second and fourth planar elements are coplanar.

13. The system of claim 12, further comprising a ruler for measuring placement of the first and second objects on the first and second apparatuses.

14. The system of claim 13, further comprising a horizontal level for measuring a horizontally level position of the first and second apparatuses.

15. The system of claim 14, further comprising a lip disposed horizontally along an edge of the second planar element, the lip for arresting movement of the first object when resting on top of the second planar element.

16. The system of claim 15, further comprising a lip disposed horizontally along an edge of the fourth planar element, the lip for arresting movement of the second object when resting on top of the fourth planar element.
